(19) United States
(12) Patent Application Publication
(10) Pub. No.: US 2019/0106310 A1
(43) Pub. Date: Apr. 11, 2019

(54) AUTOMATIC DEVICE FOR POURING PRESSURIZED FOAMED AND CARBONATED BEVERAGES INTO CONTAINERS

(71) Applicant: Sergei Aleksandrovich BUCHIK, Novosibirsk (RU)

(72) Inventor: Sergei Aleksandrovich BUCHIK, Novosibirsk (RU)

(21) Appl. No.: 16/088,591

(22) PCT Filed: Jul. 1, 2016
(86) PCT No.: PCT/RU2016/000409

§ 371 Date: Sep. 26, 2018

(51) Int. Cl. B67C 3/08; B67C 3/06; B67C 3/10; B67C 3/12; B67C 3/20; B67C 3/26

(52) U.S. Cl. CPC B67C 3/08; B67C 3/06; B67C 3/2617; B67C 3/12; B67C 3/20; B67C 3/10

(57) ABSTRACT

The invention relates to devices for automatically pouring foamed and carbonated beverages from isobaric containers into plastic bottles. The technical result is an automatic device with a simplified design, which is easier to maintain as a result of the valves of a flow switcher being provided with a single common stepped electromechanical cam drive. The present automatic device comprises a filling channel, channels, valves with pipes for supplying a gas and a beverage, a channel for removing gas from a container, said channel being connected via an adjustable throttle valve to a drainage channel, an assembly for clamping the neck of a plastic container to the outlet opening of the filling channel and to the inlet opening of the gas removal channel, and a control unit, which is connected to a drive of the clamping assembly and to a drive of valves in order to open and close same according to a set programme. The drive of valves comprises a disc which is mounted such as to be capable of discrete angular displacement and has a profiled cammed surface in the form of an annular track which contacts with rods corresponding to the valves and provides, in one complete revolution of the disc, for the opening and closing of said valves according, to a set programme in order to pour a beverage into a container.

The invention relates to devices for automatically pouring foamed and carbonated beverages from an isobaric container into plastic bottles in retail kiosks, stores, restaurants, and bars and is useful in the commercial equipment of the food industry.

A semiautomatic device for pouring and sealing beverages into plastic bottles from an isobaric container under counterpressure is known (Patent for utility model of the Russian Federation No. 14924, IPC B 67 C 3/00, published on 10 Sep. 2000), the device comprising: a platform; a sealing unit having a rotary drive of heads, said sealing unit being disposed on the platform on columns; a pouting unit having heads for supplying a beverage under counterpressure into plastic bottles, said pouring unit being connected via pipes to the isobaric container; a bottle holder having a fork for holding bottles by the neck shoulders; and a control unit for controlling the device, said control unit having a pneumatic system.

A semiautomatic device for pouring and sealing beverages into, plastic bottles from an isobaric container under counterpressure is known (Patent for utility model of the Russian Federation No. 37359, IPC B 67 C 7/00, published on 20 Apr. 2004), the device comprising: a pouring unit disposed on a mobile traverse, said pouring unit having heads, filling tubes and a drive for its vertical reciprocal movement; said pouring unit being connected via pipes to a beverage supply container; a cap feeder having a mechanism for feeding caps; a sealing unit for sealing a bottle, said sealing unit having a drive for vertical movement of sealing heads; an assembly for moving bottles; and a control system for controlling the semiautomatic device, said control system having a control panel.

However, the analogues cited above are intended for industrial pouring of beverages into plastic containers, have large dimensions, require considerable areas to place the equipment and can not be used in retail trade (bars, restaurants, cafes, and stores).

The closest technical solution (prototype) is an automatic device for pouring foamed and carbonated beverages from an isobaric container into bottles under counterpressure (international application WO2012123768, published on 20 Sep. 2012), the device comprising: a filling channel connected via channels having electromagnetic valves to pipes for supplying a gas from a cylinder and a beverage from a keg; an assembly for clamping the neck of a plastic container to the outlet opening of the filling channel; a channel for removing the gas from a beverage container, said channel being connected via an adjustable throttle electromagnetic valve to a drainage channel; a transducer of a beverage level in the beverage container; and a control unit connected to the beverage level transducer, to a drive of the clamping assembly and to a drive of the electromagnetic valves in order to open and close same according to a set program. The assembly for clamping the beverage container to the outlet opening of the filling channel is made in the form of a platform and a drive for its vertical reciprocal movement. The container for pouring a beverage is placed on the platform.

However, said automatic device has an elaborate design and large dimensions caused by the fact that each valve is provided with a separate electromagnetic drive in order to open and close same. Furthermore, said automatic device has a low maintainability, since the whole valve with the electromagnetic drive has to be changed if it is required to replace a valve closure.

The technical result of the claimed invention is an increased compactness, a simplified design of the automatic device and an improved maintainability thereof, as a result of the valves of a flow switch being provided with a single common stepped electromechanical cam drive.

The aforementioned technical result is achieved by the fact that in an automatic device for pouring pressurized foamed and carbonated beverages into containers, the device comprising: a filling channel (2) connected via channels (3 and 4) having valves (5 and 6) respectively, to pipes (7 and 8) for supplying a gas and a beverage; a channel (11) for removing the gas from a container (10), said channel being connected via an adjustable throttle valve (12) to a drainage channel (13); an assembly (9) for clamping the neck of the plastic container (10) to the outlet opening of the filling channel (2) and to the inlet opening of the us removal channel (11); and a control unit (14) connected to a drive of the clamping assembly (9) and to a drive of the valves (5, 6 and 12) in order to open and close same, according to a set program, according to the present invention, the drive of the valves (5, 6 and 12) comprises a disk (26) which is mounted such as to be capable of discrete angular movement and has a profiled cammed surface (28) in the form of annular tracks (29) which contact with stems (30, 31 and 32) corresponding to the valves (5, 6 and 12) and provide, in one complete revolution of the disk (26), for the opening and closing of said valves according to the set program in order to pour a beverage into the container (10).

In the first embodiment, the assembly (9) for clamping the neck of the container (10) is disposed above the container (10) near the outlet opening of the filling channel (2) and the inlet opening of the gas removal channel (11), is provided with a holder for holding the neck of the container (10) and comprises: a piston (17) disposed in the cavity (18) of the housing (1) of the automatic device, the filling channel (2) and the channel (11) for removing the gas from the container (10) extending through said piston; a spring (19) for returning the piston (17) into its starting position to the upper end wall (20) of the cavity (18); a resilient elastic sealing ring (21) disposed on the outer side of the lower end wall of the piston (17) around the outlet openings of the channels (2 and 11); a valve (22) arranged in the channel (23), said channel connecting the gas supply channel (3) to the cavity (l 8) above the piston (17); and a valve (24) disposed in the channel (25), said channel connecting the cavity (18) above the piston (17) to the channel (11) for removing the gas from the container (10), wherein each stem (33 and 34) corresponding to the valves (22 and 24) contacts with an annular track (29) on the profiled cammed surface (28) of the disk (26), and the holder for holding the neck of the container (10) is made in the form of a fork (35) for accommodating the neck of the container (10) therein, said fork being integral with the housing (1) of the automatic device upstream of the outlet opening of the channel (2) and the inlet opening of the channel (11).

In the second embodiment, the assembly (9) for clamping the neck of the container (10) to the outlet opening of the filling channel (2) and to the inlet opening of the gas removal channel (11) is disposed below the container (10) and comprises a platform (37) for accommodating the container (10) thereon, the neck of said container being arranged below the outlet opening of the filling channel (2) and the inlet opening of the channel (11), and a mechanism (38) for vertical reciprocal movement of the platform (37), said mechanism being kinematically coupled to the platform (37).

The control unit (14) comprises a pressure sensor (15) and a flowmeter (16) coupled thereto, wherein said pressure sensor (15) is connected to the gas supply channel (3) by one outlet and to the channel (11) for removing the gas front the container (10) by the other outlet, and said flowmeter (16) is arranged in the beverage supply channel (4) upstream of the valve (5) in the beverage movement direction.

As a result of the valves of the flow switch being provided with a single common stepped electromechanical cam drive, an increased compactness, a simplified deign of the automatic device and an improved maintainability thereof are achieved.

The invention is illustrated by the following drawings,

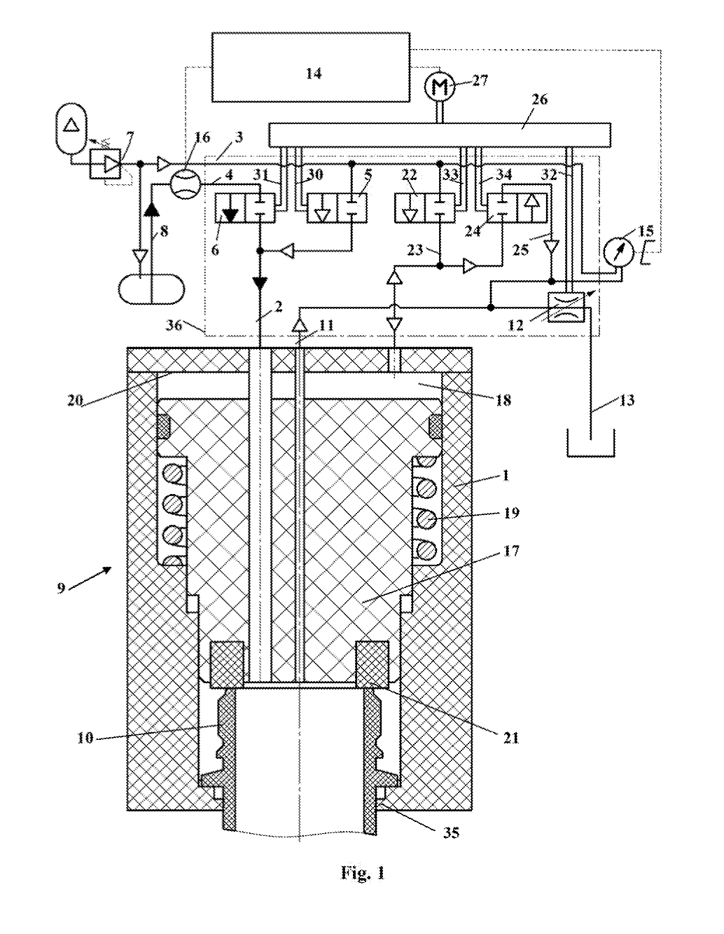

FIG. 1 demonstrates a scheme of an automatic device for pouring pressurized foamed and carbonated beverages into plastic containers (contains the first embodiment of the assembly for clamping the neck of the container).

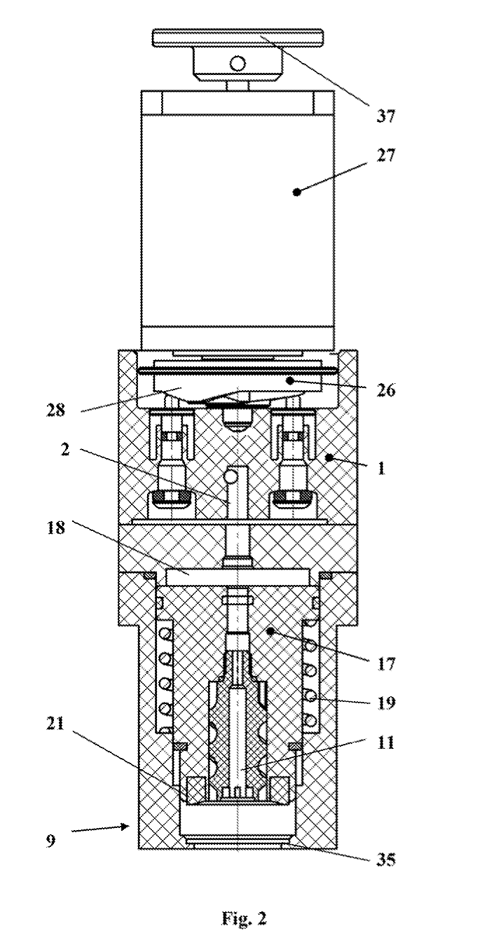

FIG. 2 shows a sectional view of the device.

FIG. 3 represents a diagram of disposing cams on the annular tracks of the disk of the electromechanical drive of the valves.

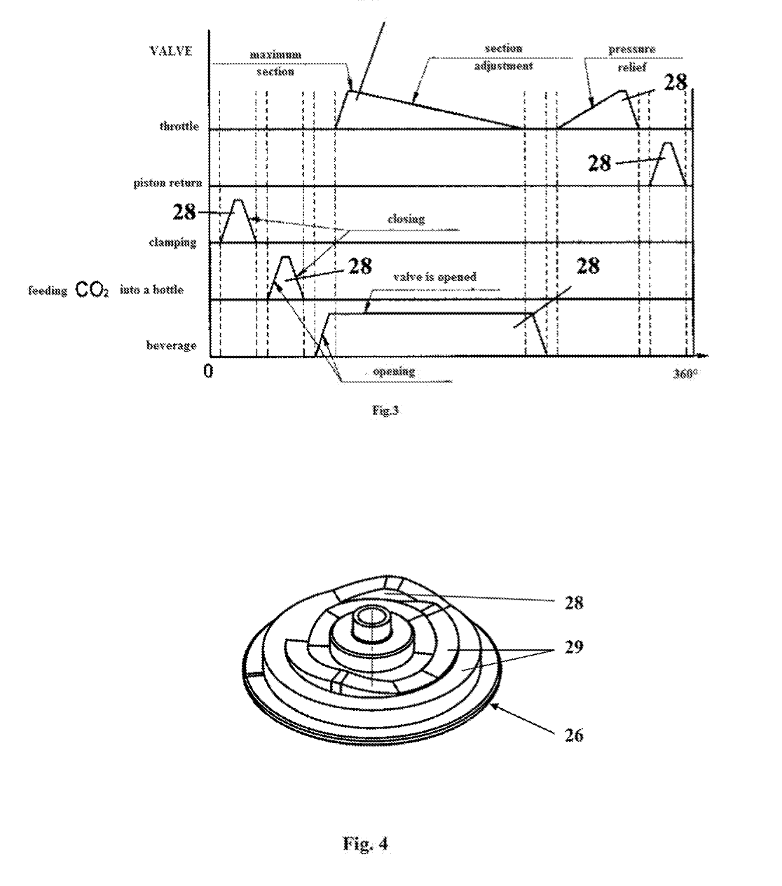

FIG. 4 demonstrates a disk of the electromechanical drive of the valves, said disk having annular tracks.

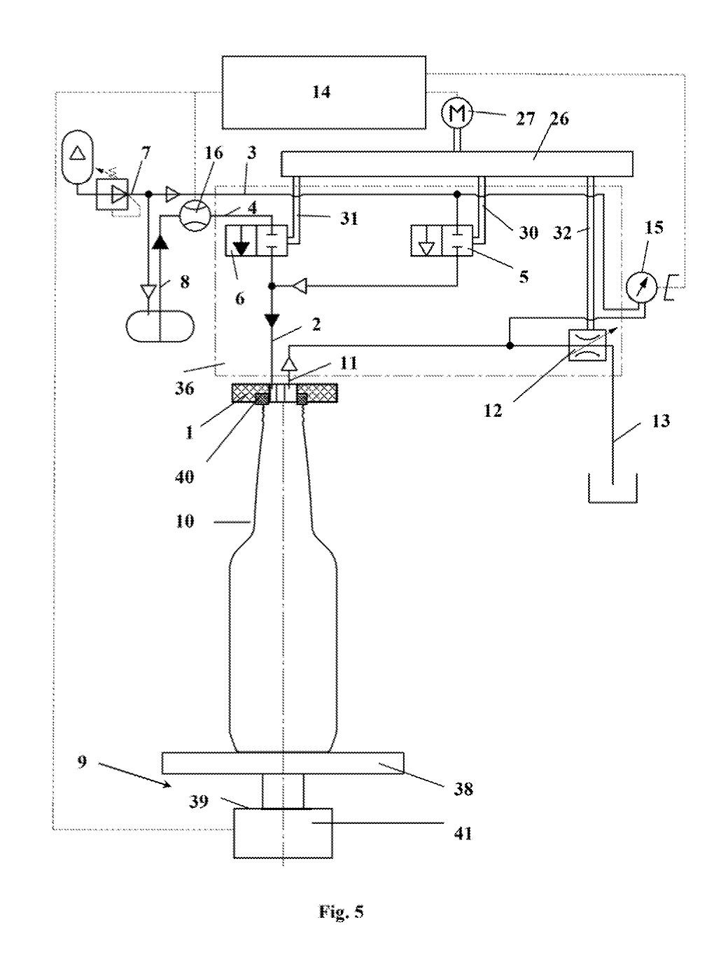

FIG. 5 shows a scheme of an automatic device for pouring pressurized foamed and carbonated beverages into plastic containers (contains the second embodiment of the assembly for clamping the neck of the container).

An automatic device for pouring foamed and carbonated beverages comprises a housing (1), said housing accommodating: a tilling channel (2) connected via channels (3 and 4) having valves (5 and 6) to pipes (7 and 8) for supplying a gas and a beverage, respectively; an assembly (9) for clamping the neck of a plastic container (10) to the outlet opening of the Idling channel (2); a channel (11) for removing the gas from the container (10), said channel being connected via an adjustable throttle valve (12) to a drainage channel (13); and a control unit (controller) (14).

The control unit (14) is provided with a pressure sensor (15) and a flowmeter (16) connected thereto via wires. The sensor (15) is connected to the gas supply channel (3) by one outlet and to the channel (11) for removing the gas from the container (10) by the other outlet, and the flowmeter (16) is arranged in the beverage supply channel (4) upstream of the valve (6) in the beverage movement direction.

In the first embodiment, the assembly (9) for clamping the neck of the container (10) is disposed around the outlet opening of the filling channel (2) and the inlet opening of the channel (11) for removing the gas from the container (10) and is provided with a holder for holding the neck of said container (10). The assembly (9) for clamping, the neck of the container (10) comprises: a piston (17) disposed in the cavity (18) of the housing (1) of the automatic device, the filling channel (2) and the channel (11) for removing the gas from the container (10) extending though said piston; a spring (19) for returning the piston (17) into its starting position to the upper end wall (20) of the cavity (18); a resilient elastic sealing ring (21) disposed on the outer side of the lower end wall of the piston (17) around the outlet openings of the channels (2 and 11); a valve (22) arranged in the channel (23), said channel connecting the gas supply channel (3) to the cavity (18) above the piston (17); and a valve (24) disposed in the channel (25), said channel connecting the cavity (18) above the piston (17) to the channel (11) for removing the gas from the container (10).

The valves (5, 6, 12, 22 and 24) are provided with an electromechanical drive comprising a disk (26) with a stepped electrical motor (27) for rotating the disk (26), said disk having a profiled cammed surface (28) in the form of an annular track (29) which contacts with the stems (30, 31, 32, 33 and 34) of the valves (5, 6, 12, 22 and 24) and provides, in one complete revolution of the disk (26), for the opening and dosing of said valves according to a set program in order to pour a beverage into the container (10).

Each of the stems (30, 31, 32, 33 and 34) corresponding to the valves (5, 6, 12, 22 and 24) contacts with the annular track (29) on the profiled canned surface (28) of the disk (26). The holder for holding the neck of the container (10) is made in the form of a fork (35) for accommodating the neck of the container (10) therein, said fork being rigidly coupled to the housing (1) of the automatic device and disposed upstream of the outlet opening of the channel (2) and the inlet opening of the channel (11).

The stepped electrical motor (27) for rotating the disk (26) of the electromechanical drive of the valves (5, 6, 12, 22 and 24) is connected to the control unit (14).

The valves (5, 6, 12, 22 and 24) are mounted densely to each other and are a compact valve unit (36). The electromechanical drive of the valves (5, 6, 14, 22 and 24) has a handle (37) for manually rotating the disk (26) having a rammed surface (28), said handle being used when adjusting the automatic device or switching off the electric power supply of the motor (27).

In the second embodiment, the assembly (9) for clamping the neck of the container (10) to the outlet opening of the filling channel (2) and to the inlet opening of the gas removal channel (11) is disposed below the container (10) and comprises a platform (38) for accommodating said container (10) thereon and a mechanism (39) for vertical reciprocal movement of the platform (38), said mechanism being kinematically coupled to the platform (38). The platform (38) is mounted coaxially with a resilient elastic sealing ring (40) disposed on the outer side of the housing (1) of the automatic device around the outlet opening of the channel (2) and the inlet opening of the channel (11). The mechanism (39) for vertical reciprocal movement of the platform (38) is made, for example, in the form of a “bolt-nut” or “tenon-mortise” screw pair with a hand drive or a drive from an electric motor (41). The electric motor (41) is coupled to the control unit (14).

The automatic device operates in the following way. When the device is switched on, the disk (26) having cams (28) is, mounted into its starting position, the presence of pressure in the gas supply pipe (7) is checked and the switching to a waiting mode is performed.

A beverage is poured in the following way. An operator mounts a plastic container (10) onto the fork (35) (FIG. 1, the first embodiment of the assembly (9) for clamping the container) or onto the platform (38) (FIG. 5, the second embodiment of the assembly (9) for clamping the container) and presses a trigger button (not shown in the figures).

The control unit (14) (controller) triggers the electric motor (27) for stepped rotation of the disk (26) having a rammed surface (28).

In the first embodiment of the assembly (9) for clamping the container (10), first the stem (33) is outpressed and the valve (22) for supplying a gas into the cavity (18) above the piston (17) is opened. The, plastic container (10) is tightly clamped to the resilient elastic ring (21) for communicating its inner cavity with the outlet opening of the filling channel (2) and the inlet opening of the channel (11).

In the second embodiment of the assembly (9) for clamping the container (10), an operator manually rotates the handle (not shown in the figures) of the “bolt-nut” or “tenon-mortise” drive, or the electric motor (41) is switched on by means of the control unit (14), the motor rotating the “bolt-nut” or “tenon-mortise” drive, whereby the Platform (38) ascends and the neck of the container (10) is tightly clamped to the sealing ring (40). Further, the disk (26) rotates into a position (FIG. 4) which, a cam (28) outpresses the stem (30), the valve (5) is opened and connects the gas supply channel (3) to the container (10). The gas is supplied until the pressure between the container (10) and the pipe (8) connected to the compressed gas cylinder is equalized. During the further stepped rotation of the disk (26), the valve (5) for supplying a gas into the container (10) is closed, the stem (31) is outpressed and the valve (6) for supplying a beverage (beer) is opened. Since there is no pressure differential between the container (10) and the pipe (8) from the keg with beer, the beverage does not move. The further stepped rotation of the disk (26) provides for a smooth movement of the stem (32), a smooth opening of the throttle valve (12), and a discharge of carbon dioxide into the drainage channel (13). In this case, the length of the angled cammed surface (28) of the disk (26) provides for an accurate arrangement of the flow section of the channel of the throttle valve (12) in order to provide for a predetermined gas flow from the container (10) and maintain a required pressure drop between said container (10) and the keg with the beverage. The pressure drop is monitored by means of the pressure sensor (15). The value of the pressure differential can be set directly during the beverage pouring process. In this case, the values of said pressure differential are permanently stored by the control unit (14) and will be used in the next pouring. During the pouring process, the flow meter (16) calculates the beverage volume required for pouring (takes into account the consumption of the beverage supplied from the keg) and transmits the data to the control unit (14). A smooth control of the section of the throttle valve (12) during the pouring process allows for an accurate adjustment of the operation of the automatic device for each type of a beverage irrespective of its characteristics (viscosity, foaming) and a selection of an optimal combination of a pouring rate and a foam level. When the pouring is finished, the throttle valve (12) and the beverage supply valve (6) are fully closed. During the further rotation of the disk (26), the throttle valve (12) is opened again and smoothly reduces the pressure in the container (10) (with the beverage supply valve (6) being dosed) to the atmospheric pressure. In this case, the relief rate is controlled according to the readings of the pressure sensor (15), ensuring minimal foaming.

In the first embodiment of the assembly (9), when the pressure in the container (10) is equalized to the atmospheric pressure, the subsequent rotation of the disk (26) provides for the movement of the stem (34), the opening of the valve (24) and the pressure relief from the cavity (18), alter which the disk (26) stops and the spring (19) returns the piston (17) into its starting position, the neck of the container (10) is released and the container (10) is removed by an operator from the fork (35). After the disk (26) makes a complete stepped revolution, all the valves (5, 6, 12, 22 and 24) are in their initial closed state.

In the second embodiment of the assembly (9), when the pressure in the container (10) is equalized to the atmospheric pressure, the disk (26) makes a complete stepped revolution and all the valves (5, 6, 12) are in their initial closed state. An operator manually rotates the handle (not shown in the figures) of the “bolt-nut” or “tenon-mortise” drive in the reverse direction, or the electric motor (41) is switched on by means of the control unit (14), the motor rotating said “bolt-nut” or “tenon-mortise” drive in the reverse direction, whereby the platform (38) descends, the neck of the container (10) is released and the container (10) is removed by the operator from the platform (38).

After the operation is finished, the automatic device, is washed (washed with water every day, and washed with acid once a week), which is carried out in the following way. An operator, instead of a keg with beer, connects a washing liquid keg, mounts the container (10) of a small volume onto the fork (35) and starts a washing mode. At this moment, the control unit (14) switches on the drive (the electric motor 27) for the stepped rotation of the disk (26) having a cammed surface (28). This opens the valve (22) for supplying a gas into the cavity (18) and the piston (17) descends to clamp the container (10) to the openings of the channels (2, 11) and to the fork (35). Further, the disk (26) having cams rotates to open the valve (5) for supplying a gas into the container (10), the channel (3) of the valve (5) being connected to the washing liquid supply channel (2). The gas is supplied until the pressure differential between the container (10) and the main line becomes zero. At this moment, the calmed surface (28) of the disk (26) is in the position of a maximum opened section of the throttle valve (12) and the washing liquid supply valve (6). The pressure is relieved from the container (10) and the container (10) is filled with the washing liquid at a maximum rate. When the container (10) is overfilled, the washing liquid is discharged into the drainage channel (13) and the entire pouring system of the automatic device is washed. When the washing is finished, the throttle valve (12) and the washing liquid supply valve (6) are fully closed. Subsequently, the throttle valve (12) is opened again and reduces the pressure in the container (10) (with the washing liquid supply valve (6) being closed) to the atmospheric pressure. When the pressure is equalized to the atmospheric pressure, the disk (26) having the cammed surface (28) is in the position of relieving the pressure from the cavity (18), the spring (19) returns the piston (17) into its starting upper position, the neck of the container (10) is released from clamping and is removed from the fork (35).

It follows from the foregoing description that as a result of the valves of the flow switch being provided with a single common electromechanical cam drive, an increased compactness, a simplified design of the automatic device and an improved maintainability thereof are achieved.

1. An automatic device for pouring pressurized foamed and carbonated beverages into containers, the device comprising: a filling channel (2) connected via channels (3 and 4) having valves (5 and 6), respectively, to pipes (7 and 8) for supplying a gas and a beverage; a channel (11) for removing the gas from a container (10), said channel being connected via an adjustable throttle valve (12) to a drainage channel (13); an assembly (9) for clamping the neck of the container (10) to the outlet opening of the fitting channel (2) and to the inlet opening of the gas removal channel (11); and a control unit (14) connected to a drive of the assembly (9) for clamping the neck of the container (10) and to a drive of the valves (5, 6 and 12) in order to open and close same according to a set program, characterized in that the drive of the valves (5, 6 and 12) comprises a disk (26) which is mounted such as to be capable of discrete angular movement and has a profiled calmed surface (28) in the form of annular tracks (29) which contact with stems (30, 31 and 32) corresponding to the valves (5, 6 and 12) and provide, in one complete revolution of the disk (26), for the opening and closing of said valves according to the set program in order to pour a beverage into the container (10).

2. The automatic device according to claim 1, characterized in that the assembly (9) for clamping the neck of the container (10) is disposed above the container (10) near the outlet opening of the filling channel (2) and the inlet opening of the gas removal channel (11), is provided with a holder for holding the neck of the container (10) and comprises: a piston (17) disposed in the cavity (18) of the housing (1) of the automatic device, the filling channel (2) and the channel (11) for removing the gas from the container (10) extending through said piston; a spring (19) for returning the piston (17) into its starting position to the upper end wall (20) of the cavity (18); a resilient elastic sealing ring (21) disposed on the outer side of the lower end wall of the piston (17) around the outlet openings of the channels (2 and 11); a valve (22) arranged in the channel (23), said channel connecting the channel (3) for supplying a gas to the cavity (18) above the piston (17); and a valve (24) disposed in the channel (25), said channel connecting the cavity (18) above the piston (17) to the channel (11) for removing the gas from the container (10), wherein each stem (33 and 34) corresponding to the valves (22 and 24) contacts with its annular track (29) on the profiled calmed surface (28) of the disk (26), and the holder for holding the neck of the container (10) is made in the form of a fork (35) for accommodating the neck of the container (10) therein, said fork being integral with the housing (1) a the automatic device upstream of the outlet opening of the channel (2) and the inlet opening of the channel (11).

3. The automatic device according to claim characterized in that the assembly (9) for clamping the neck of the container (10) to the outlet opening of the channel (2) and to the inlet opening of the gas removal channel (11) is disposed below the container (10) and comprises a platform (38) for accommodating the container (10) thereon and a mechanism (39) for vertical reciprocal movement of the platform (38), said mechanism being kinematically coupled to the platform (38).

4. The automatic device according to claim 1, characterized in that the control unit (14) comprises a pressure sensor (15) and a flowmeter (16) coupled thereto, wherein the pressure sensor (15) is connected to the gas supply channel (3) by one outlet and to the channel (11) for removing the gas from the container (10) by the other outlet, and the flowmeter (16) is arranged in the beverage supply channel (4) upstream of the valve (6) in the beverage movement direction.
